(19) United States
(12) Patent Application Publication
(10) Pub. No.: US 2026/0274392 A1
(43) Pub. Date: Sep. 17, 2026

(54) AIRCRAFT ASSEMBLY AND AIRCRAFT

(71) Applicant: Airbus Operations GmbH, HAMBURG (DE)

(72) Inventors: Martin SIEMANN, HAMBURG (DE); Erkan KIRTIL, HAMBURG (DE)

(21) Appl. No.: 19/179,660

(22) Filed: Apr. 15, 2025

(30) Foreign Application Priority Data
Apr. 17, 2024 (EP) 24170835.3

(51) Int. Cl. B64C 1/06; B64D 37/04; B64D 37/30

(52) U.S. Cl. CPC B64C 1/069; B64D 37/04; B64D 37/30

(57) ABSTRACT

An aircraft assembly comprising two or more aircraft components which are connected with each other by one or various tethers. The tethers are configured to delimit a drifting apart of the aircraft components in case of a breakage of the aircraft assembly during a potential crash scenario. The aircraft components may include a fuel tank.

### CROSS-REFERENCES TO RELATED APPLICATIONS

This application claims the benefit of European Patent Application Number 24170835.3 filed on Apr. 17, 2024, the entire disclosure of which is incorporated herein by way of reference.

### FIELD OF THE INVENTION

The present invention concerns an aircraft assembly, which in particular may comprise (or be) an aircraft's fuselage. The invention further concerns an aircraft comprising such aircraft assembly.

### BACKGROUND OF THE INVENTION

Aircraft typically comprise, inter alia, a fuselage with a shell encompassing a passenger cabin and/or a cargo hold, and encasing various constituents such as one or more fuel tank/s. In potential crash scenarios, the fuselage may rupture, in particular may occur at locations where there is a rather sudden change of stiffness or some type of local load introduction, such as behind a cockpit section, forward or aft the center wing box and/or close to the empennage.

Certification specifications require to avoid fuselage breakage in particular near tanks.

Different positions are known for the tanks, depending on a respective type and design of the aircraft.

The requirements were defined with respect to conventionally powered aircraft, where the respective fuel may be an aviation gasoline or a jet fuel, for instance.

However, in order to achieve a considerable emission reduction, alternative propulsion systems for aircraft have been researched for. In this respect, hydrogen/electric aircraft engines, any propulsion engine, which includes piston engines, turbine engines of any architecture, and fuel cell powered electrical propulsion motors have emerged as a promising possibility, for instance. In particular, turbo fans and fuel cells/electric engines respectively powered by hydrogen are being developed as aircraft engines.

There are two basic tank variants: integral and non-integral tanks. Integral tanks comprise tank boundaries that form at least a part of the airframe and are thus load-carrying, whereas non-integral tanks are installed in the airframe and comprise tank boundaries/walls that are not part of the airframe and thus they are not load-carrying.

Because of the large size of hydrogen tanks necessary for such hydrogen propulsion, a fuselage containing such hydrogen tank may break, in particular in front of, behind and/or between such hydrogen tanks (respectively with regard to a designated direction of normal flight).

### SUMMARY OF THE INVENTION

It is an object of the present invention to provide an aircraft assembly accomplishing an improved safety. It is a further object to provide an aircraft comprising such an aircraft assembly.

The object may be achieved with an aircraft assembly and/or with an aircraft according to one or more embodiments described herein.

An aircraft assembly (thus, a set-up which forms part or is configured to form part of an aircraft) according to the present invention comprises two or more components of the aircraft which are connected with each other by means of one or various tether/s (which thus are further comprised by the aircraft assembly). Thereby, the tether/s is/are configured to delimit a drifting apart of the aircraft components if the aircraft assembly ruptures, i.e., it is/they are adapted to keep the aircraft components together (i.e., in a predefined maximum distance) in case of a potential breakage of the aircraft assembly.

The present invention thus inhibits that said connected aircraft components separate and move in an uncontrolled manner if the aircraft assembly breaks. This minimizes the risk of secondary impacts which otherwise might occur, when the aircraft comprising the aircraft assembly ruptures, in particular, when a shell thereof breaks up. For instance, when the at least two aircraft components belong to an aft portion of a fuselage of the aircraft, the connection thereof by means of the tether/s facilitates avoiding that one of said aircraft components blocks an aft door of the fuselage. Accordingly, in particular the aft door's capability to serve as an emergency evacuation path for passengers and/or crew can be maintained. Moreover, said connection may obviate that, in a potential crash scenario, one of said components penetrates into a passenger cabin or the aircraft's cockpit, and/or that it is displaced into an environment of the aircraft, which might cause additional risks. In particular, the tether/s thus is/are safety tether/s.

As long as the aircraft assembly is undamaged, the one tether or—if the aircraft assembly comprises various tethers—at least one of the tethers is preferably arranged to be slack (thus, not taut) between the two or more aircraft components it connects. Accordingly, the (at least one) tether is preferably loaded only in case of a potential crash scenario where a rupture between components of the airframe occurs, but unloaded during normal operations (flight and ground loads) of the aircraft comprising the aircraft assembly. Thereby, a durability of the (at least one) tether and of respective mounts and/or fastening means is improved.

Accordingly, the tethers do only act when there is a rupture between connected components, e.g., a fuselage break. They do not form part of the primary structure or contribute to carrying loads during normal operations nor during potential crash scenarios where there is no rupture between connected components.

According to advantageous embodiments of the present invention, the aircraft assembly includes at least a portion of a fuselage of the aircraft. Additionally or alternatively, it may comprise at least a portion of at least one wing, at least one engine, at least a portion of a tail, an empennage, and/or an undercarriage, respectively of the aircraft.

At least one of said two or more aircraft components may be a structural component of the aircraft. For example, such structural component may be a section of a fuselage of the aircraft, in particular a section of a shell of the fuselage, even more specifically, a section of a shell of an aft portion of the fuselage. According to advantageous embodiments, such portion may form part of a fuselage reinforcement structure of the aircraft.

Additionally or alternatively, the two or more aircraft components connected with each other by means of one or various tether/s may comprise at least one fuel tank, at least one pressure bulkhead, at least one engine pylon and/or at least one landing gear of the aircraft. In particular, the present invention thus advantageously facilitates a retention of such items of mass.

As further possibilities, at least one of the two or more aircraft components may belong to a fuel distribution system of the aircraft, in particular to a pipe system thereof. In such case, the tethers may advantageously help to avoid rupture of components of the fuel distribution systems, as they limit their elongation in case of a potential rupture between components of the airframe.

In particular, the two of more aircraft components which are connected with each other by means of the tether/s may be of the same type, or they may be of different types.

For instance, they may both be a structural component of the aircraft (in particular, a structural component of one of the above-mentioned kinds), or both be a fuel tank of the aircraft.

As an example of said aircraft components being of different types, one of said two of more aircraft components may be a structural component (e.g., of one of the above-mentioned kinds) or a pressure bulkhead, whereas the other one (connected thereto) may be a fuel tank or an engine pylon of the aircraft.

As is to be understood, the aircraft assembly according to the present invention may additionally or alternatively comprise, as said aircraft components connected by means of the tether/s, further combinations, in particular of the mentioned aircraft components exemplarily mentioned herein.

In embodiments comprising at least one fuel tank as at least one of the aircraft components which are connected with each other by means of the tether/s, said at least one fuel tank may advantageously be arranged in an aft portion of the aircraft's fuselage, for instance, in a caudal tandem configuration with a/the other fuel tank.

Additionally or alternatively, said at least one fuel tank may in particular be a pressure vessel configured to contain liquid hydrogen. Such embodiments in particular advantageously combine a low emission aircraft propulsion with a high safety of the aircraft.

According to advantageous embodiments comprising at least one fuel tank as at least one of said aircraft components, the aircraft assembly further comprises at least a portion of a pipe and supply system configured to supply fuel contained in the at least one fuel tank to one or more (main) propulsion engines of the aircraft and/or to an auxiliary power unit possibly further comprised by the aircraft or even the fuselage.

The one tether or—if applicable—at least one of the various tethers (by means of which the two or more aircraft components are connected with each other) may be fixed to at least one of the aircraft components with at least one further element in-between. For instance, such element may be a fixation element which may be attached to a respective one of the aircraft components and to which the (at least one) tether may be fastened. Accordingly, a respective connection of the aircraft components (with each other) may be formed by the tether/s in conjunction with said at least one element.

Additionally or alternatively, within a shell the aircraft assembly may comprise, the tether or—if applicable—at least one of the various tethers may be at least partially bare (i.e., exposed/without a casing). For instance, it may run along at least one tank attachment of a fuel tank of the aircraft, in particular along a tank attachment of at least one fuel tank being (in respective embodiments) one of said aircraft components as mentioned above. Such embodiments facilitate a particular simple installation.

According to advantageous embodiments of the present invention, the one tether or—if the assembly comprises various tethers—at least one of the tethers is at least partially made of polymer fibers, such as aramids or polyethylene, carbon fibers, such as Kevlar, or inorganic fibers such as glass or ceramic. Thereby, the tether/s may exhibit a high tensile strength and, nevertheless, a low mass.

### BRIEF DESCRIPTION OF THE DRAWINGS

In what follows, an exemplary embodiment of the present invention is explained with respect to the accompanying drawings. As is to be understood, the various elements and components are depicted as examples only, may be facultative and/or combined in a manner different than that depicted. Reference signs for related elements are used comprehensively and not necessarily defined again for both figures.

Shown are schematically in:

FIG. 1a is an aircraft assembly according to an exemplary embodiment of the present invention in an undamaged state;

FIG. 1b is the aircraft assembly of FIG. 1a after a potential crash scenario where a rupture between components of the airframe has occurred; and

FIG. 2: is an aircraft assembly according to another exemplary embodiment of the present invention in an undamaged state.

### DETAILED DESCRIPTION OF THE PREFERRED EMBODIMENTS

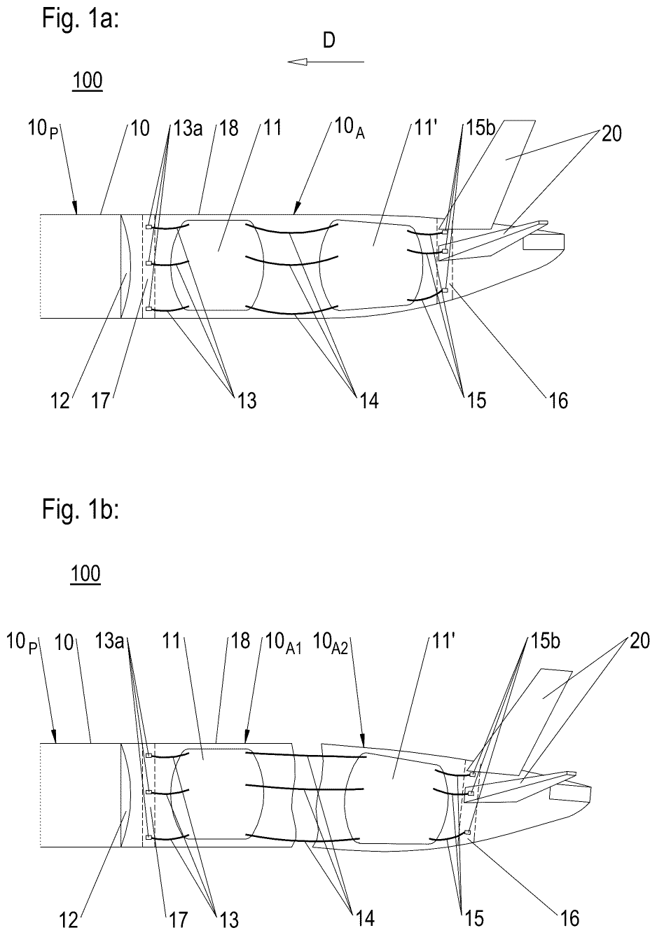

FIGS. 1a and 1b illustrate an exemplary aircraft assembly 100 according to the present invention in an undamaged and in a damaged state, respectively. In this embodiment, the aircraft assembly 100 comprises a part of a fuselage 10 of an aircraft, the fuselage 10 including an unpressurised aft portion 10_{A} and a part of a passenger cabin 10_{P}, which are separated from each other by a pressure bulkhead 12. Furthermore, the aircraft assembly comprises an empennage 20 which is attached to the fuselage's aft portion 10_{A}.

The unpressurised aft portion 10_{A} comprises two fuel tanks 11, 11′ arranged in caudal tandem configuration. The fuel tanks 11, 11′ may in particular be hydrogen tanks, i.e., pressure vessels configured to contain liquid hydrogen. Preferably, the fuel tanks 11, 11′ are connected or configured to be connected, by means of a pipe and supply system (not shown), with one or more (main) propulsion engines of the aircraft and/or with an auxiliary power unit possibly further comprised by the aircraft.

The aircraft assembly 100 further comprises a plurality of tethers 13, 14, 15 each of which is attached to two aircraft components which thus are connected with each other by means of the respective tethers. Indeed, a portion 17 of the fuselage's shell 18 (e.g., a portion of a fuselage reinforcement structure) in the proximity of the pressure bulkhead 12 and a first fuel tank 11 adjacent thereto constitute a first pair of such aircraft components which are connected to each other by means of a plurality of tethers 13, the connection comprising fixation elements 13a respectively attached to said portion 17 of the shell 18 of the fuselage. The first fuel tank 11 and the second fuel tank 11′ (constituting a second pair of aircraft components) are connected to each by means of a plurality of tethers 14. Finally, the second fuel tank 11′ and a section 16 of the shell 18 aft the fuel tank 11′ make up a third pair of aircraft components which are connected to each by means of a plurality of tethers 15, wherein the connection comprises fixation elements 15b respectively attached to said section 16 of the shell 18.

As can be seen in FIG. 1a, in the undamaged state, the tethers 13, 14, 15 are arranged to be slack (and thus unloaded) between the two or more aircraft components they respectively connect.

By contrast, in the damaged state shown in FIG. 1b, in which the aft portion 10_{A} of the fuselage 10 is broken into pieces 10_{A1} and 10_{A2}, some of the tethers 15 are taut due to the pieces 10_{A1}, 10_{A2} having moved apart. Indeed, in the exemplary case depicted, the rupture has caused the piece 10_{A2} to bend downwards relative to the piece 10_{A1}, such that the upmost one of tethers 15 has been loaded and thereby inhibits a further drifting apart of the fuel tanks 11, 11′. Respective mounts (not shown in the figures) fastening the fuel tanks 11, 11′ to the shell 18 may further prevent, in combination with the tethers 15 and the fuel tanks 11, 11′, that the respective shell portions of the pieces 10_{A1}, 10_{A2} further separate from each other.

Therefore, safety of the aircraft comprising the aircraft assembly 100 is increased in a potential crash scenario.

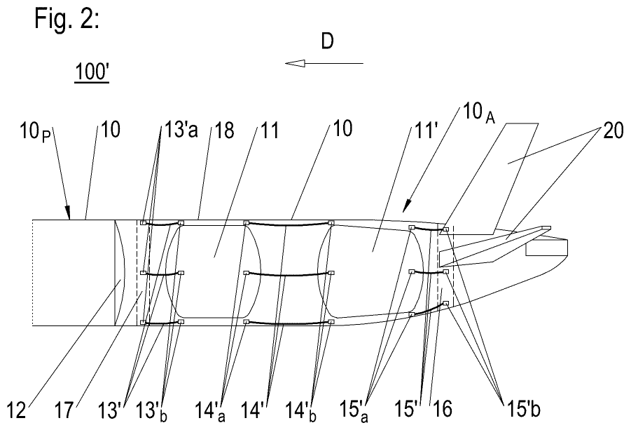

In FIG. 2, an aircraft assembly 100′ according to another embodiment of the present invention is illustrated in an undamaged state. The aircraft assembly 100′ differs from the embodiment shown in FIGS. 1a, 1b in that its tethers 13′, 14′, 15′ are not fastened to the tanks 11, 11′. Instead, they are connected to respective structural components of the shell 18, the structural components respectively surrounding one of the tanks 11, 11′. For example, such structural component in this case may be a frame (not shown) comprised by a fuselage reinforcement structure of the shell 18. The respective connection comprises fixation elements 13′a, 13′b, 14′a, 14′b, 15′a, 15′b (such as fittings) which are respectively attached to the structural components and to which the tethers 13′, 14′, 15′ are fastened.

As is to be understood, the present invention is not restricted to the embodiments shown in the figures. In particular, an aircraft assembly according to the present invention may comprise both at least one tether having at least one end which is connected to a tank (as shown in FIG. 1a), and at least one tether which is connected, at both of its ends, to a structural component, as illustrated on FIG. 2.

Disclosed is an aircraft assembly 100 comprising two or more aircraft components 11, 11′, 16, 17 which are connected with each other by means of one or various tether/s 13, 13′, 14, 14′, 15, 15′. The tether/s is/are configured to delimit a drifting apart of the aircraft components 11, 11′, 16, 17 in case of a breakage of the aircraft assembly.

Further disclosed is an aircraft comprising such aircraft assembly 100, 100′.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SIGNS

10 fuselage
10_{A} aft portion of the fuselage 10
10_{A1}, 10_{A2} pieces of the aft portion 10_{A}
10_{P} passenger cabin of the fuselage 10
11, 11′ fuel tank
12 pressure bulkhead
13, 13′ tethers
13a, 13′a, 13′b fixation element
14, 14′ tether
14′a, 14′b fixation element
15 tether
15b, 15′a, 15′b fixation element
16 shell section/structural component
17 portion of fuselage shell/structural component
20 empennage
100, 100′ aircraft assembly

Claimed is:

1. An aircraft assembly comprising:
two or more aircraft components connected with each other by one or more tethers configured to delimit a drifting apart of the two or more aircraft components in case of a breakage of the aircraft assembly.

2. The aircraft assembly according to claim 1, wherein the two or more aircraft components comprise:
at least one structural component; or
at least one fuel tank; or
at least one pressure bulkhead; or
at least one engine pylon; or
at least one landing gear; or
any combination thereof.

3. The aircraft assembly according to claim 1, wherein the two or more aircraft components comprise at least one fuel tank.

4. The aircraft assembly according to claim 3, wherein the at least one fuel tank is connected by at least one of the one or more tethers with a further fuel tank of the aircraft assembly; or
wherein the at least one fuel tank is connected by at least one of the one or more tethers with a structural component of the aircraft assembly, or both.

5. The aircraft assembly according to claim 3, wherein the at least one fuel tank is configured as a pressure vessel for containing liquid hydrogen.

6. The aircraft assembly according to claim 2, wherein within a shell of by the aircraft assembly, at least one of the one or more tethers is at least partially bare.

7. The aircraft assembly according to claim 1, wherein a connection of the two or more aircraft components with each other further comprises at least one fixation element attached to one or more of the two or more aircraft components.

8. The aircraft assembly according to claim 1, wherein at least one of the one or more tethers is at least partially made of polymer fibers, carbon fibers, or inorganic fibers.

9. The aircraft assembly according to claim 1, wherein at least one of the one or more tethers is configured to be slack within the aircraft assembly, while the aircraft assembly is undamaged.

10. An aircraft comprising:
the aircraft assembly according to claim 1.
